(19) United States
(12) Patent Application Publication
(10) Pub. No.: US 2016/0137905 A1
(43) Pub. Date: May 19, 2016

(54) COMPOSITION FOR FINES AGGLOMERATION

(71) Applicant: HALLIBURTON ENERGY SERVICES, INC., Houston, TX (US)

(72) Inventors: Prajakta Ratnakar Patil, Pune (IN); Shoy Chittattukara George, Thrissur (IN); Prasanta Das, Laskarpur (IN)

(21) Appl. No.: 14/896,863

(22) PCT Filed: Aug. 6, 2013
(86) PCT No.: PCT/US2013/053825

§ 371 Date: Dec. 8, 2015

(51) Int. Cl. C09K 8/575; C09K 8/42; C09K 8/88; C09K 8/68; C09K 8/72; C09K 8/035; C09K 8/60

(52) U.S. Cl. CPC C09K 8/5753; C09K 8/035; C09K 8/42; C09K 8/608; C09K 8/68; C09K 8/725; C09K 8/882; C09K 2208/02

(57) ABSTRACT

A method of treating a subterranean formation, the method includes: obtaining or providing a composition comprising a cationic polymer and water; and contacting the composition with a subterranean material downhole.

### BACKGROUND OF THE INVENTION

The migration of fines involves the movement of fine clay and/or non-clay particles (e.g. quartz, amorphous silica, feldspars, zeolites, carbonates, salts and micas) or similar materials within a subterranean reservoir formation due to drag and other forces during production of hydrocarbons or water. Fines migration may result from an unconsolidated or inherently unstable formation, or from the use of an incompatible treatment fluid that liberates fine particles. Fines migration may cause the very small particles suspended in the produced fluid to bridge the pore throats near the wellbore, thereby reducing well productivity. Damage created by fines is typically located within a radius of about 3 to 5 feet (about 1 to 2 meters) of the wellbore, and may occur in gravel-pack completions and other operations.

Fines migration is a complex phenomenon believed to be governed largely by mineralogy, permeability, salinity and pH changes, as well as drag forces created by flow velocity, turbulence and fluid viscosity, as described in detail in J. Hibbeler, et al., “An Integrated Long-Term Solution for Migratory Fines Damage,” SPE 81017, SPE Latin American and Caribbean Petroleum Engineering Conference, Port-of-Spain, Trinidad, West Indies, 27-30 Apr. 2003, incorporated herein by reference in its entirety. The authors note that mobilization of fines can severely damage a well's productivity, and that fines damage is a multi-parameter complex issue that may be due to one or more of the following downhole phenomena: (1) High flow rates, particularly abrupt changes to flow rates; (2) wettability effects, (3) ion exchange; (4) two-phase flow, particularly due to turbulence that destabilize fines in the near-wellbore region; and (5) acidizing treatments of the wrong type or volume which can cause fines.

J. Hibbeler, et al. note that fines, especially clays, tend to flow depending on their wettability, and since fines are typically water-wet, the introduction of water may trigger fines migration. However, they note that clay particles may become oil-wet or partially oil-wet, due to an outside influence, and thus the fines and clay particles may become attracted to and immersed in the oil phase. The authors also note that all clays have an overall negative charge and that during salinity decrease, pH increases in-situ due to ion exchange. A pH increase may also be induced via an injected fluid. As pH increases, surface potential of fines increases until de-flocculation and detachment occurs, aggravating fines migration.

Fines fixation has become troublesome during oil and gas production and during many oil and gas recovery operations, such as acidizing, fracturing, gravel packing, and secondary and tertiary recovery procedures. Hydraulic fracturing is a method of using pump rate and hydraulic pressure to fracture or crack a subterranean formation. Once the crack or cracks are made, high permeability proppant, relative to the formation permeability, is pumped into the fracture to prop open the crack. When the applied pump rates and pressures are reduced or removed from the formation, the crack or fracture cannot close or heal completely because the high permeability proppant keeps the crack open. The propped crack or fracture provides a high permeability path connecting the producing wellbore to a larger formation area to enhance the production of hydrocarbons.

Gravel packing is a sand-control method employed to prevent the production of formation sand. In gravel pack operations, a steel screen is placed in the wellbore and the surrounding annulus packed with a gravel of a specific size designed to prevent the passage of formation sand. The goal is to stabilize the formation while causing minimal impairment to well productivity. Operations combining fracturing and gravel packing are termed “frac packs.”

Weatherford® (Houston, Tex.) markets the SandAid™ technology as a chemical method for sand conglomeration. A review of the U.S. Trademark Office (Trademark Electronic Search System) provides the following description for the goods and services from the registrant: “chemical additive for stimulation fluids that change the zeta potential of solid surfaces to create enhanced conductivity in the proppant pack and control fines migration, offering enhanced load recovery during flowback operations in the field of oil and gas drilling and recovery.”

### SUMMARY OF THE INVENTION

In various embodiments, the present invention provides a method of treating a subterranean formation. The method includes obtaining or providing a composition comprising a cationic polymer and water; and contacting the composition with a subterranean material downhole.

In various embodiments, the present invention provides a method of agglomerating subterranean formation particles. The method includes obtaining or providing a composition comprising a cationic polymer and water; and contacting the composition with a subterranean material downhole.

In various embodiments, the present invention provides a method of decreasing the amount of small-sized particles in a subterranean formation. The method includes obtaining or providing a composition comprising a cationic polymer and water; and contacting the composition with a subterranean material downhole.

In various embodiments, the present invention provides a method of reducing particle migration located downhole. The method includes obtaining or providing a composition comprising a cationic polymer and water; and contacting the composition with a subterranean material downhole.

In various embodiments, the present invention provides a method of decreasing the amount of subterranean particles from entering into a downhole well. The method includes obtaining or providing a composition comprising a cationic polymer and water; and contacting the composition with a subterranean material downhole.

In various embodiments, the present invention provides a method of forming agglomerated particles in a subterranean formation. The method includes obtaining or providing a composition comprising a cationic polymer and water; and contacting the composition with a subterranean material downhole.

In specific embodiments, advantages of the present invention provide for a composition that is suitable for treating a subterranean formation, wherein the treatment is reversible and non-damaging to the formation. The composition includes a cationic polymer and water, yet does not include any appreciable or significant amount of resin. In such embodiments, the lack of any significant or appreciable amount of resin in the composition avoids or decreases the likelihood of premature curing before the composition reaches the target zone, as well as avoids or decreases the likelihood of damage to the formation (e.g., damage that would negatively impact the formation permeability).

In specific embodiments, advantages of the present invention provide for the use of the composition described herein, in combination with at least one of an aqueous drilling fluid and an oil-based drilling fluid.

In specific embodiments, advantages of the present invention provide for the use of the composition described herein, in agglomerating subterranean formation particles, without damaging subterranean formation permeability.

In specific embodiments, advantages of the present invention provide for the use of the composition described herein, in decreasing the amount of small-sized particles in a subterranean formation, without damaging subterranean formation permeability.

In specific embodiments, advantages of the present invention provide for the use of the composition described herein, in reducing particle migration located downhole, without damaging subterranean formation permeability.

In specific embodiments, advantages of the present invention provide for the use of the composition described herein, in decreasing the amount of subterranean particles from entering into a downhole well, without damaging subterranean formation permeability.

In specific embodiments, advantages of the present invention provide for the use of the composition described herein, in forming agglomerated particles in a subterranean formation, without damaging subterranean formation permeability.

In specific embodiments, advantages of the present invention provide for the composition described herein, having a relatively low viscosity, thereby facilitating penetration into a formation.

### BRIEF DESCRIPTION OF THE FIGURES

FIG. 1 illustrates fluid collected at 200 psi (A) Without DADMAC treatment (highly turbid) solution (B) After DADMAC treatment (transparent solution), in accordance with various embodiments.

FIG. 2 illustrates scanning electron micrographs for Silica flour+20/40 sand (50:50) without chemical treatment, in accordance with various embodiments.

FIG. 3 illustrates scanning electron micrographs for Silica flour+20/40 sand (50:50) after DADMAC treatment in dry condition, in accordance with various embodiments.

FIG. 4 illustrates scanning electron micrographs for Silica flour+20/40 sand (50:50) after DADMAC treatment in wet condition, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%, etc.) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “downhole” as used herein refers to under the surface of the earth, such as a location within or fluidly connected to a wellbore.

The term “permeability” as used herein refers to a measure of the ease of which liquids or gas move through a porous material.

The term “impermeable” as used herein is a descriptive term for earth materials which have a texture or structure that does not permit fluids to perceptibly move into or through its pores or interstices.

The term “porosity” as used herein refers to the percentage of pore volume or void space, or that volume within rock that can contain fluids. Shale gas reservoirs tend to have relatively high porosity, but the alignment of platy grains such as clays makes their permeability very low.

The term “reservoir” as used herein refers to a subsurface body of rock having sufficient porosity and permeability to store and transmit fluids. Sedimentary rocks are the most common reservoir rocks because they have more porosity than most igneous and metamorphic rocks and form under temperature conditions at which hydrocarbons can be preserved. As such, the term “reservoir with porosity and permeability” as used herein refers to a reservoir having the requisite porosity and permeability.

The term “formation” as used herein refers to the rock around the borehole. The term refers to an assemblage of earth materials grouped together into a unit that is convenient for description or mapping.

The term “consolidated formation” as used herein refers to any geologic formation in which the earth materials have become firm and cohesive through natural rock forming processes. Such rocks include, e.g., basalt, granite, sandstone, shale, conglomerate, and limestone.

The term “unconsolidated formation” as used herein refers to any naturally occurring, loosely cemented, or poorly consolidated earth material including such materials as uncompacted gravel, sand, silt and clay.

The term “gravel pack” or “artificial gravel pack” as used herein refers to a mixture of gravel or sand placed in the annular space around the liner, perforated pipe, or well screen. A gravel pack is used to reduce the movement of finer material into the well and provide lateral support to the screen in unstable formations.

The term “screens” or “well screens” as used herein refer to a device, usually made of plastic or metal, capable of preventing unconsolidated or poorly consolidated geologic material from entering the well. The size of the material which is prevented from entering the well is predetermined and controlled by the screen opening or slot size of the screen. A well screen may include a riser pipe.

In open hole completion, often sand screens with or without a gravel pack are installed. These maintain structural integrity of the wellbore in the absence of casing, while still allowing flow from the reservoir into the wellbore. Screens also control the migration of formation sands into production tubulars and surface equipment, which can cause washouts and other problems, particularly from unconsolidated sand formations of offshore fields.

The term “sandstone” as used herein refers to sedimentary rock whose grains are predominantly sand-sized. The term is commonly used to imply consolidated sand or a rock made of predominantly quartz sand, although sandstones often contain feldspar, rock fragments, mica and numerous additional mineral grains held together with silica or another type of cement. The relatively high porosity and permeability of sandstones make them good reservoir rocks.

The term “sandstone formation” as used herein refers to a formation that includes sandstone. For example, the sandstone formation can include at least about 50 wt. % quartz.

The term “production zone” as used herein refers to the relevant portion of a subterranean formation, and surrounding area, that includes the well, open hole, casing, production tubing, and the associated downhole tools.

The term “treatment zone” as used herein refers to the relevant portion of the production zone, in which the compositions described herein are placed.

The term “particle” as used herein refers to a substance having a relatively small size. For example, the substance can have a diameter of up to about 500 microns.

The term “without damaging subterranean formation permeability” as used herein refers to essentially maintaining the permeability of a formation. The subterranean formation permeability will not be considered damaged, e.g., when at least about 80% of the formation permeability is maintained. In specific embodiments, the subterranean formation permeability will not be considered damaged, e.g., when at least about 85% of the formation permeability is maintained. In further specific embodiments, the subterranean formation permeability will not be considered damaged, e.g., when at least about 90% of the formation permeability is maintained. In further specific embodiments, the subterranean formation permeability will not be considered damaged, e.g., when at least about 95% of the formation permeability is maintained.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean material can be any section of a wellbore and any section of an underground formation in fluid contact with the wellbore, including any materials placed into the wellbore such as cement, drill shafts, liners, tubing, or screens. In some examples, a subterranean material can be any below-ground area that can produce liquid or gaseous petroleum materials, water, or any section below-ground in fluid contact therewith.

The term “substituted” or “substituted alkyl” is intended to indicate that one or more hydrogen atoms on the alkyl group is replaced with a selection from the indicated group(s), provided that the indicated atom's normal valency is not exceeded, and that the substitution results in a stable compound. Suitable indicated groups include, e.g., alkenyl, alkylidenyl, alkenylidenyl, alkoxy, halo, haloalkyl, hydroxy, hydroxyalkyl, aryl, heteroaryl, heterocycle, cycloalkyl, alkanoyl, acyloxy, alkoxycarbonyl, amino, imino, alkylamino, acylamino, nitro, trifluoromethyl, trifluoromethoxy, carboxy, carboxyalkyl, keto, thioxo, alkylthio, alkylsulfinyl, alkylsulfonyl, cyano, acetamido, acetoxy, acetyl, benzamido, benzenesulfinyl, benzenesulfonamido, benzenesulfonyl, benzenesulfonylamino, benzoyl, benzoylamino, benzoyloxy, benzyl, benzyloxy, benzyloxycarbonyl, benzylthio, carbamoyl, carbamate, isocyannato, sulfamoyl, sulfinamoyl, sulfino, sulfo, sulfoamino, thiosulfo, NRxRy and/or COORx, wherein each Rx and Ry are independently H, alkyl, alkenyl, aryl, heteroaryl, heterocycle, cycloalkyl or hydroxy. When a substituent is keto (i.e., ═O) or thioxo (i.e., ═S) group, then 2 hydrogens on the atom are replaced.

### Method of Treating a Subterranean Formation

The composition described herein is useful for treating a subterranean formation (e.g., for use in downhole sand control). Without being bound to any particular theory, it is believed that relatively small-sized (e.g., less than 50 microns in diameter) particles located in a subterranean formation can be agglomerated with a composition that includes a cationic polymer and water. In various embodiments, the present invention provides a method of treating a subterranean formation. The method can include obtaining, or providing, a composition that includes a cationic polymer and water. The method can also include contacting the composition with a subterranean material downhole.

In various embodiments, the method of treating a subterranean formation can include at least one of: (1) agglomerating subterranean formation particles, (2) decreasing the amount of small-sized particles in a subterranean formation, (3) reducing particle migration located downhole, (4) decreasing the amount of subterranean particles from entering into a downhole well, and (5) forming agglomerated particles in a subterranean formation. In any one or more of the above embodiments, the method is carried out without damaging subterranean formation permeability.

As stated above, relatively small-sized particles located in a subterranean formation can be agglomerated with a composition that includes a cationic polymer and water. In various embodiments, the relatively small-sized particles can have a diameter of less than 500 microns, less than 250 microns, less than 100 microns, less than 50 microns, less than 25 microns, less than 10 microns, or less than 5 microns.

The composition that contacts the subterranean material can be formed in any suitable location and at any suitable time. In various embodiments, the composition can be formed above the surface, or at or near the downhole location. In some embodiments, the composition can be formed downhole. For example, at least one of the cationic polymer and water can be placed downhole (e.g., pumped, injected) to join a downhole fluid mixture that is present downhole to form the composition that contacts the subterranean material. In another embodiment, the obtaining or providing of the composition can be performed above the surface. For example, a suitable downhole fluid can be combined with at least one of the cationic polymer and water above the surface to form the composition that can contact the subterranean material downhole.

The treatment of the subterranean formation can occur at any suitable time (and over any suitable period of time). In various embodiments, the treatment of the subterranean formation can occur at least about 2, 2.5, 3, 3.5, 4, 4.5, 5, 5.5, 6, 6.5, 7, 7.5, 8, 8.5, 9, 9.5 or 10 hours, after contacting the composition with the subterranean material downhole. In additional various embodiments, the treatment of the subterranean formation can occur up to about 4, 2, 3, 2, 1, or 0.5 days after contacting the composition with the subterranean material downhole. In additional various embodiments, the treatment of the subterranean formation can occur up to about 96, 72, 48, 24, 18, 16, 14, 13, 12, 11, 10, 9, 8, 7 or 6 hours after contacting the composition with the subterranean material downhole. In additional various embodiments, the treatment of the subterranean formation can occur between about 2.5 hours and 4 days, after contacting the composition with the subterranean material downhole. In additional various embodiments, the treatment of the subterranean formation can occur between about 2-96, 2-72, 2-48, 2-24, 2-18, 2-26, 2.5-15, 2.5-10, 3-10, 3.5-10, 3.5-9.5, 3.5-9, 4-9, 4.5-9, 4.5-8.5, 5-8.5 and 5-8 hours, after contacting the composition with the subterranean material downhole.

The conditions during the contacting of the composition with the subterranean material downhole can be any suitable conditions. In some embodiments, the conditions can be non-extreme conditions. In other embodiments, the conditions can be extreme conditions. In various embodiments, extreme conditions can include conditions typically considered at least one of high, ultra, or extreme. In some embodiments, during the contacting of the composition with the subterranean material downhole, the conditions include at least one of high temperature conditions, high salinity conditions, high pressure conditions, and high pH conditions, and lower pH conditions.

During the contacting of the composition with the subterranean material, the downhole temperature can be any suitable temperature. In various embodiments, during the contacting of the composition with the subterranean material downhole, the conditions can include a temperature of about 20 to about 300° F., or about 20 to about 250° F., or less than about 300° F. In additional various embodiments, during the contacting of the composition with the subterranean material downhole, the conditions can include a temperature of at least about 20, 50, 75, 100, 125, 150, 175, 200, 225, 250 or 275° F. In specific embodiments, during the contacting of the composition with the subterranean material downhole, the conditions can include a temperature of up to about 300, 275, 250, 225, 200, 175, 150, 125, 100, 75, or 50° F. In additional specific embodiments, during the contacting of the composition with the subterranean material downhole, the conditions can include a temperature of about 20-300° F., 50-250° F., 50-300° F., 50-250° F., or 100-300° F.

During the contacting of the composition with the subterranean material, the downhole salinity can be any suitable salinity. In some embodiments, during the contacting of the composition with the subterranean material downhole, the conditions can include a salt concentration of about 0.001 ppg to about 16 ppg. In various embodiments, during the contacting of the composition with the subterranean material downhole, the conditions can include a salt concentration of at least about 0.001, 0.005, 0.01, 0.05, 0.1, 0.5, 1.0, 1.5, 2, 4, 6, 8, 10, 12, or 14 ppg. In additional various embodiments, during the contacting of the composition with the subterranean material downhole, the conditions can include a salt concentration of up to about 16, 15.5, 15, 14.5, 14, 13.5, 13, 12.5, 12, 11.5, 11, 10.5, 10, 9, 8, 7, 6, 5, 4, 3, 2, 1, 0.5, 0.1, 0.05, 0.01, 0.005, or 0.001 pounds per gallon (ppg).

In various embodiments, the salt can include at least one of NaCl, KCl, KBr, NaBr, CaCl₂, CaBr₂, ZnBr₂, and ZnCl₂. In various embodiments, the salt can include a mixture of two or more of NaCl, KCl, KBr, NaBr, CaCl₂, CaBr₂, ZnBr₂, and ZnCl₂ (e.g., KCl+KBr, NaCl+NaBr, KCl+NaCl, NaCl+CaCl₂, CaCl₂+CaBr₂, CaCl₂+ZnCl₂, etc.). During the contacting of the composition with the subterranean material, the downhole pressure can be any suitable pressure. In some embodiments, during the contacting of the composition with the subterranean material downhole, the conditions can include a pressure of about 100 psi to about 30,000 psi, about 500 psi to about 25,000 psi, or about 1,000 psi to about 20,000 psi.

In various embodiments, during the contacting of the composition with the subterranean material downhole, the conditions can include a pressure of at least about 10 psi, 50 psi, 100 psi, 250 psi, 500 psi, 750 psi, 1,000 psi, 5,000 psi, 7,500 psi, 10,000 psi, 12,500 psi, 15,000 psi, 17,500 psi, 20,000 psi, 22,500 psi, 25,000 psi, or 27,500 psi.

In various embodiments, during the contacting of the composition with the subterranean material downhole, the conditions can include a pressure of up to about 25,000 psi, 22,500 psi, 20,000 psi, 17,500 psi, 15,000 psi, 12,500 psi, 10,000 psi, 7,500 psi, 6,000 psi, 5,000 psi, 4,500 psi, 4,000 psi, 3,000 psi, 2,000 psi, 1,000 psi, 750 psi, 500 psi, 250 psi, 100 psi, or 50 psi.

In various embodiments, during the contacting of the composition with the subterranean material downhole, the conditions can include a pressure of at least to about 50 psi, 100 psi, 250 psi, 500 psi, 750 psi, 1,000 psi, 2,000 psi, 3,000 psi, 4,000 psi, 4,500 psi, 5,000 psi, 6,000 psi, 7,500 psi, 10,000 psi, 12,500 psi, 15,000 psi, 17,500 psi, 20,000 psi, or 22,500 psi.

During the contacting of the composition with the subterranean material, the downhole pH can be any suitable pH. In some embodiments, during the contacting of the composition with the subterranean material downhole, the conditions can include a pH of about 0 to about 14, about 1 to about 13, or about 2 to about 12. In some embodiments, during the contacting of the composition with the subterranean material downhole, the conditions can include a pH of at least about 0.5, 1, 2, 3, 4, 5, 6, 7, 8, 9, 10, 11, 12, 13, or 13.5. In some embodiments, during the contacting of the composition with the subterranean material downhole, the conditions can include a pH of less than about 14, 13, 12, 11, 10, 9, 8, 7, 6, 5, 4, 3, 2, or 1.

In specific embodiments, during the contacting of the composition with the subterranean material downhole, the conditions can include a pH of about 6 to about 8. In specific embodiments, during the contacting of the composition with the subterranean material downhole, the conditions can include a pH of at least about 6, 6.25, 6.5, 6.75, 7, 7.25, 7.5, or 7.75. In specific embodiments, during the contacting of the composition with the subterranean material downhole, the conditions can include a pH of less than about 8. 7.75, 7.5, 7.25, 7, 6.75, 6.5, or 6.25.

The viscosity of the composition prior to the contacting of the composition with the subterranean formation can be any suitable viscosity. In some embodiments, the composition prior to contacting with the subterranean material (e.g. before placing downhole, or before the composition reaches the subterranean material downhole) can be free-flowing, while in other embodiments the composition can be a thick liquid. In various embodiments, the viscosity of the composition prior to contacting with the subterranean material can be about 1 cP to about 5 cP, measured at standard temperature and pressure and shear rate. In various embodiments, the viscosity of the composition prior to contacting with the subterranean material can be at least about 1 cP, 1.5 cP, 2 cP, 2.5 cP, 3 cP, 3.5 cP, 4 cP, or 4.5 cP, measured at standard temperature and pressure and 511 shear rate. In various embodiments, the viscosity of the composition prior to contacting with the subterranean material can be up to about 5 cP, 4.5 cP, 4 cP, 3.5 cP, 3 cP, 2.5 cP, 2 cP, or 1.5 cP, measured at standard temperature and pressure and 511 shear rate.

The viscosity of the composition subsequent to the contacting of the composition with the subterranean formation can be any suitable viscosity. In some embodiments, the composition subsequent to contacting with the subterranean material (e.g. after placing downhole, or after the composition reaches the subterranean material downhole) can have a viscosity of about 1 cP to about 5 cP, measured at standard temperature and pressure. In various embodiments, the resulting viscosity of the composition can be at least about 1 cP, 1.5 cP, 2 cP, 2.5 cP, 3 cP, 3.5 cP, 4 cP, or 4.5 cP, measured at standard temperature and pressure and 511 shear rate. In various embodiments, the resulting viscosity of the composition can be up to about 5 cP, 4.5 cP, 4 cP, 3.5 cP, 3 cP, 2.5 cP, 2 cP, or 1.5 cP, measured at standard temperature and pressure and 511 shear rate.

### Composition

In various embodiments, the invention provides for the use of a composition that includes a cationic polymer and water, for use in treating a subterranean formation. As described herein, the method can include contacting the composition with a subterranean material downhole.

Any suitable cationic polymer can be employed. In various embodiments, composition does not further include a resin. In specific embodiments, the composition will not include an appreciable or significant amount of resin. As used herein, “resin” refers to any component of a liquid that will set into a hard lacquer or enamel-like finish, and includes, e.g., natural, synthetic (e.g., epoxy resins), and semi-synthetic viscous liquids, composed mainly of volatile fluid terpenes, with lesser components of dissolved non-volatile solids which make resin thick and sticky. The most common terpenes in resin are the bicyclic terpenes alpha-pinene, beta-pinene, delta-3 carene and sabinene, the monocyclic terpenes limonene and terpinolene, and smaller amounts of the tricyclic sesquiterpenes, longifolene, caryophyllene and delta-cadinene. Some resins also contain a high proportion of resin acids. The individual components of resin can be separated by fractional distillation.

In specific embodiments, the composition will not include an appreciable or significant amount of resin, such that any resin present therein is present in less than about 0.1 wt. % of the composition. In specific embodiments, the composition will not include an appreciable or significant amount of resin, such that any resin present therein is present in less than about 0.05 wt. % of the composition. In such embodiments, the lack of any significant or appreciable amount of resin in the composition avoids or decreases the likelihood of premature curing before the composition reaches the target zone, as well as avoids or decreases the likelihood of damage to the formation.

The cationic polymer can have a suitable molecular weight. In specific embodiments, the cationic polymer has a molar mass of at least about 10,000 g/mol. In specific embodiments, the cationic polymer has a molar mass of at least about 20,000 g/mol. In specific embodiments, the cationic polymer has a molar mass of at least about 50,000 g/mol. In specific embodiments, the cationic polymer has a molar mass of at least about 100,000 g/mol. In specific embodiments, the cationic polymer has a molar mass of at least about 150,000 g/mol. In specific embodiments, the cationic polymer has a molar mass of at least about 250,000 g/mol. In specific embodiments, the cationic polymer has a molar mass of at least about 350,000 g/mol. In specific embodiments, the cationic polymer has a molar mass of at least about 500,000 g/mol. In specific embodiments, the cationic polymer has a molar mass of at least about 650,000 g/mol. In specific embodiments, the cationic polymer has a molar mass of at least about 750,000 g/mol.

In specific embodiments, the cationic polymer has a molar mass of up to about 1,000,000 g/mol. In specific embodiments, the cationic polymer has a molar mass of up to about 750,000 g/mol. In specific embodiments, the cationic polymer has a molar mass of up to about 500,000 g/mol. In specific embodiments, the cationic polymer has a molar mass of up to about 250,000 g/mol. In specific embodiments, the cationic polymer has a molar mass of up to about 100,000 g/mol. In specific embodiments, the cationic polymer has a molar mass of up to about 75,000 g/mol. In specific embodiments, the cationic polymer has a molar mass of up to about 10,000 g/mol.

The cationic polymer can have a suitable and appropriate solubility in water. In specific embodiments, the cationic polymer has a solubility in water, at 25° C. and 100 kPa, of at least about 10 g/L. In specific embodiments, the cationic polymer has a solubility in water, at 25° C. and 100 kPa, of at least about 25 g/L. In specific embodiments, the cationic polymer has a solubility in water, at 25° C. and 100 kPa, of at least about 50 g/L. In specific embodiments, the cationic polymer has a solubility in water, at 25° C. and 100 kPa, of at least about 100 g/L. In specific embodiments, the cationic polymer has a solubility in water, at 25° C. and 100 kPa, of at least about 150 g/L.

In specific embodiments, the cationic polymer has a solubility in water, at 25° C. and 100 kPa, of up to about 250 g/L. In specific embodiments, the cationic polymer has a solubility in water, at 25° C. and 100 kPa, of up to about 200 g/L. In specific embodiments, the cationic polymer has a solubility in water, at 25° C. and 100 kPa, of up to about 150 g/L. In specific embodiments, the cationic polymer has a solubility in water, at 25° C. and 100 kPa, of up to about 100 g/L. In specific embodiments, the cationic polymer has a solubility in water, at 25° C. and 100 kPa, of up to about 75 g/L. In specific embodiments, the cationic polymer has a solubility in water, at 25° C. and 100 kPa, of up to about 50 g/L.

In specific embodiments, the cationic polymer has a solubility in water, at 25° C. and 100 kPa, of about 10 g/L to about 250 g/L. In specific embodiments, the cationic polymer has a solubility in water, at 25° C. and 100 kPa, of about 20 g/L to about 200 g/L. In specific embodiments, the cationic polymer has a solubility in water, at 25° C. and 100 kPa, of about 25 g/L to about 150 g/L.

In specific embodiments, the cationic polymer includes a homopolymer. In specific embodiments, the cationic polymer includes a high charge density cationic polymer. In specific embodiments, the cationic polymer includes a quaternary ammonium salt.

In specific embodiments, the cationic polymer includes a compound of formula (I):

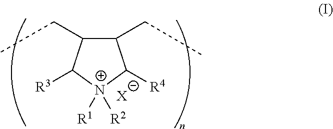

wherein,

each of R¹-R⁴ is independently —H, alkyl, or substituted alkyl; X is a suitable atom or group, capable of forming the monovalent anion; and

n is 2 to about 250,000.

In specific embodiments, each of R¹ and R² is independently alkyl. In further specific embodiments, each of R¹ and R² is methyl.

In specific embodiments, each of R³ and R⁴ is —H.

In specific embodiments, X is halo (e.g., F, Cl, Br, or I), acetate, benzenesulfonate, benzoate, formate, mesylate, nitrate, or stearate. In further specific embodiments, X is halo (e.g., F, Cl, Br, or I). In further specific embodiments, X is Cl.

In specific embodiments, n is 2 to about 200,000. In specific embodiments, n is 10 to about 200,000. In specific embodiments, n is 25 to about 200,000. In specific embodiments, n is 50 to about 200,000. In specific embodiments, n is 100 to about 200,000. In specific embodiments, n is 150 to about 200,000. In specific embodiments, n is 200 to about 200,000. In specific embodiments, n is 250 to about 200,000. In specific embodiments, n is 500 to about 200,000. In specific embodiments, n is 750 to about 200,000. In specific embodiments, n is 1,000 to about 200,000.

Exemplary suitable cationic polymers include at least one of: polydiallyldimethylammonium chloride (polyDADMAC); cationic acrylamide emulsion comprising a copolymer of 2.5 mole % acrylamide and 7.5 mole % dimethylaminoethylmethacrylate quaternary acid salt; poly[(3-(methacryloylamino)-propyl]trimethylammonium chloride); poly (acrylamido-N-propyltrimethylammonium chloride); and chitosan-graft-poly (acrylamide-methacrylatoethyl trimethyl ammonium chloride) (PCAD). In specific embodiments, the cationic polymer includes polydiallyldimethylammonium chloride (polyDADMAC) (Cas. No. 26062-79-3).

The cationic polymer can be present in the composition in any suitable and effective amount. In specific embodiments, the cationic polymer is present in at least about 0.001 wt. % of the composition. In specific embodiments, the cationic polymer is present in at least about 0.01 wt. % of the composition. In specific embodiments, the cationic polymer is present in at least about 0.1 wt. % of the composition. In specific embodiments, the cationic polymer is present in at least about 0.5 wt. % of the composition. In specific embodiments, the cationic polymer is present in at least about 1 wt. % of the composition. In specific embodiments, the cationic polymer is present in at least about 5 wt. % of the composition. In specific embodiments, the cationic polymer is present in at least about 10 wt. % of the composition. In specific embodiments, the cationic polymer is present in at least about 15 wt. % of the composition.

In specific embodiments, the cationic polymer is present in up to about 20 wt. % of the composition. In specific embodiments, the cationic polymer is present in up to about 15 wt. % of the composition. In specific embodiments, the cationic polymer is present in up to about 10 wt. % of the composition. In specific embodiments, the cationic polymer is present in up to about 5 wt. % of the composition. In specific embodiments, the cationic polymer is present in up to about 1 wt. % of the composition.

In specific embodiments, the cationic polymer is present in about 0.001 wt. % to about 20.0 wt. % of the composition. In specific embodiments, the cationic polymer is present in about 0.01 wt. % to about 20.0 wt. % of the composition. In specific embodiments, the cationic polymer is present in about 0.01 wt. % to about 20.0 wt. % of the composition. In specific embodiments, the cationic polymer is present in about 0.01 wt. % to about 15.0 wt. % of the composition. In specific embodiments, the cationic polymer is present in about 0.01 wt. % to about 10.0 wt. % of the composition. In specific embodiments, the cationic polymer is present in about 0.01 wt. % to about 5.0 wt. % of the composition. In specific embodiments, the cationic polymer is present in about 0.01 wt. % to about 1.0 wt. % of the composition.

The composition can have any suitable pH. In various embodiments, the pH of the composition is at least about 2, 3, 4, 5, or 6. In additional various embodiments, the pH of the composition is up to about 10, 9, 8, or 7. In various embodiments, the pH of the composition is about 4-11, 4-10.5, 4.5-11, 4.5-10.5, 5-10, 5-9.5, 5.5-10, 5.5-9.5, 6.5-9, 6-9.5, or 6-9. In various embodiments, the pH of the composition is about 6-8 (e.g., 6, 6.25, 6.5, 6.75, 7, 7.25, 7.5, 7.75, or 8).

### Downhole Mixture or Composition

In various embodiments, at least one of before, during, or after the contacting of the subterranean material and the composition including at least one of a cationic polymer and water, the composition including at least one of a cationic polymer and water, that is contacted with a subterranean material can be any suitable downhole composition, such as any suitable composition used downhole for the drilling, completion, and production phases of a well. In various examples, the composition can be formed above the surface, in the borehole above a location wherein the properties of the composition are desired to be modified, or at or near the downhole location wherein the composition including at least one of a cationic polymer and water is contacted with the subterranean material. In some examples, at least one of a cationic polymer and water can include a suitable carrier material such as water or another solvent, and can be injected downhole to join a downhole fluid that is present downhole to form the composition that contacts the subterranean material. In another embodiment, a downhole fluid can be combined with at least one of a cationic polymer and water above the surface to form the composition that can contact the subterranean material downhole.

For example, in various embodiments, at least one of prior to, during, and after the contacting of the subterranean material and the composition, the composition is used downhole, at least one of alone and in combination with other materials, as a drilling fluid, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof.

As described herein, in various embodiments the composition can further include additional substances, such as, e.g., water, saline, aqueous base, oil, organic solvent, synthetic fluid oil phase, aqueous solution, alcohol or polyol, cellulose, starch, alkalinity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, gas, weight reducing additive, heavy-weight additive, lost circulation material, filtration control additive, dispersant, salt, fiber, thixotropic additive, breaker, crosslinker, gas, rheology modifier, density control agent, curing accelerator, curing retarder, pH modifier, chelating agent, scale inhibitor, enzyme, resin, water control material, polymer, oxidizer, a marker, or a combination thereof.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those of ordinary skill in the art, and that such modifications and variations are considered to be within the scope of this invention as defined by the appended claims.

### Enumerated Embodiments

Enumerated embodiments [1]-[46] provided below are for illustration purposes only and do not otherwise limit the scope of the invention, as defined by the claims. The enumerated embodiments [1]-[46] described below encompass all combinations and sub-combinations, whether or not expressly described as such.

[1.] A method of treating a subterranean formation, the method comprising:

obtaining or providing a composition comprising a cationic polymer and water; and

contacting the composition with a subterranean material downhole.

[2.] The method of the above embodiment, wherein the subterranean formation comprises a sandstone formation.
[3.] The method of any one of the above embodiments, wherein the subterranean formation comprises a sandstone formation, comprising at least about 50 wt. % quartz.
[4.] The method of any one of the above embodiments, wherein the treating the subterranean formation comprises at least one of: (1) agglomerating subterranean formation particles, (2) decreasing the amount of small-sized particles in a subterranean formation, (3) reducing particle migration located downhole, (4) decreasing the amount of subterranean particles that enter into a downhole well, and (5) forming agglomerated particles in a subterranean formation.
[5.] The method of any one of the above embodiments, wherein the treating the subterranean formation comprises at least one of: (1) agglomerating subterranean formation particles, (2) decreasing the amount of small-sized particles in a subterranean formation, (3) reducing particle migration located downhole, (4) decreasing the amount of subterranean particles from entering into a downhole well, and (5) forming agglomerated particles in a subterranean formation;

wherein subterranean formation permeability is substantially maintained.

[6.] The method of any one of the above embodiments, wherein the treating the subterranean formation comprises at least one of: (1) agglomerating subterranean formation particles, (2) decreasing the amount of small-sized particles in a subterranean formation, (3) reducing particle migration located downhole, (4) decreasing the amount of subterranean particles from entering into a downhole well, and (5) forming agglomerated particles in a subterranean formation;

wherein the particles comprise fines having a diameter of about 100 microns, or less.

[7.] The method of any one of the above embodiments, wherein the treating the subterranean formation comprises at least one of: (1) agglomerating subterranean formation particles, (2) decreasing the amount of particles in a subterranean formation, (3) reducing particle migration located downhole, and (4) decreasing the amount of subterranean particles from entering into a downhole well;

wherein the particles comprise at least one of sand and clay, having a diameter size of about 50 microns, or less.

[8.] The method of any one of the above embodiments, wherein the composition comprising the cationic polymer and the water does not further comprise a resin.
[9.] The method of any one of the above embodiments, wherein any resin present in the composition comprising the cationic polymer and the water is present in less than about 0.1 wt. % of the composition.
[10.] The method of any one of the above embodiments, wherein the cationic polymer has a molar mass of at least about 100,000 g/mol.
[11.] The method of any one of the above embodiments, wherein the cationic polymer has a molar mass of up to about 1,000,000 g/mol.
[12.] The method of any one of the above embodiments, wherein the cationic polymer has a solubility in water, at 25° C. and 100 kPa, of at least about 50 g/L.
[13.] The method of any one of the above embodiments, wherein the cationic polymer has a solubility in water, at 25° C. and 100 kPa, of up to about 2,500 g/L.
[14.] The method of any one of the above embodiments, wherein the cationic polymer comprises a compound of formula (I):

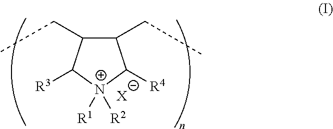

wherein,

each of R¹-R⁴ is independently —H, alkyl, or substituted alkyl;

X is a suitable atom or group of atoms, capable of forming the monovalent anion; and

n is 2 to about 250,000.

[15.] The method of any one of the above embodiments, wherein the cationic polymer comprises at least one of:

polydiallyldimethylammonium chloride (polyDADMAC);

cationic acrylamide emulsion comprising a copolymer of acrylamide and dimethylaminoethylmethacrylate quaternary acid salt;

poly[(3-(methacryloylamino)-propyl]trimethylammonium chloride);

poly (acrylamido-N-propyltrimethylammonium chloride); and

chitosan-graft-poly (acrylamide-methacrylatoethyl trimethyl ammonium chloride) (PCAD).

[16.] The method of any one of the above embodiments, wherein the cationic polymer comprises polydiallyldimethylammonium chloride (polyDADMAC), CAS No. 26062-79-3.
[17.] The method of any one of the above embodiments, wherein the composition comprising the cationic polymer and water has a pH of about 6 to about 8.
[18.] The method of any one of the above embodiments, wherein the composition comprising the cationic polymer and the water comprises the cationic polymer in up to about 20 wt. % of the composition.
[19.] The method of any one of the above embodiments, wherein the composition comprising the cationic polymer and the water comprises the cationic polymer in at least about 0.001 wt. % of the composition.
[20.] The method of any one of the above embodiments, wherein the composition comprising the cationic polymer and the water comprises the cationic polymer in about 0.01 wt. % to about 1.0 wt. % of the composition.
[21.] The method of any one of the above embodiments, wherein during the contacting of the composition with the subterranean material downhole, the conditions comprise at least one of high temperature conditions, high salinity conditions, high pressure conditions, and high pH conditions, and lower pH conditions.
[22.] The method of any one of the above embodiments, wherein the obtaining or providing of the composition is performed downhole.
[23.] The method of any one of the above embodiments, wherein the obtaining or providing of the composition is performed above the surface.
[24.] The method of any one of the above embodiments, wherein during the contacting of the composition with the subterranean material downhole, the conditions comprise a temperature of about 25° C. to about 150° C.
[25.] The method of any one of the above embodiments, further comprising combining the composition with an aqueous or oil-based fluid.
[26.] The method of any one of the above embodiments, wherein at least one of prior to, during, and after the contacting of the subterranean material and the composition, the composition is used downhole, at least one of alone and in combination with other materials, as a drilling fluid, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof.
[27.] The method of any one of the above embodiments, wherein the composition further comprises at least one of water, saline, aqueous base, oil, organic solvent, synthetic fluid oil phase, aqueous solution, alcohol or polyol, cellulose, starch, alkalinity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, gas, weight reducing additive, heavy-weight additive, lost circulation material, filtration control additive, dispersant, salt, fiber, thixotropic additive, breaker, crosslinker, gas, rheology modifier, density control agent, curing accelerator, curing retarder, pH modifier, chelating agent, scale inhibitor, enzyme, resin, water control material, polymer, oxidizer, and a marker.
[28.] A method for agglomerating subterranean formation particles, the method comprising:

obtaining or providing a composition comprising a cationic polymer and water; and

contacting the composition with a subterranean material downhole.

[29.] A method for decreasing the amount of small-sized particles in a subterranean formation, the method comprising:

obtaining or providing a composition comprising a cationic polymer and water; and

contacting the composition with a subterranean material downhole.

[30.] A method for reducing particle migration located downhole, the method comprising:

obtaining or providing a composition comprising a cationic polymer and water; and

contacting the composition with a subterranean material downhole.

[31.] A method for decreasing the amount of subterranean particles from entering into a downhole well, the method comprising:

obtaining or providing a composition comprising a cationic polymer and water; and

contacting the composition with a subterranean material downhole.

[32.] A method for forming agglomerated particles in a subterranean formation, the method comprising:

obtaining or providing a composition comprising a cationic polymer and water; and

contacting the composition with a subterranean material downhole.

[33.] A composition comprising a cationic polymer, water, and a subterranean material.
[34.] A composition comprising a (i) cationic polymer, (ii) water, and (iii) at least one of a drilling fluid, stimulation fluid, fracturing fluid, spotting fluid, clean-up fluid, production fluid, completion fluid, remedial treatment fluid, abandonment fluid, pill, acidizing fluid, cementing fluid, and packer fluid.
[35.] A composition comprising a (i) cationic polymer, (ii) water, and (iii) at least one of saline, aqueous base, oil, organic solvent, synthetic fluid oil phase, aqueous solution, alcohol or polyol, cellulose, starch, alkalinity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, gas, weight reducing additive, heavy-weight additive, lost circulation material, filtration control additive, dispersant, salt, fiber, thixotropic additive, breaker, crosslinker, gas, rheology modifier, density control agent, curing accelerator, curing retarder, pH modifier, chelating agent, scale inhibitor, enzyme, resin, water control material, polymer, oxidizer, and a marker.
[36.] The composition of any one of the above embodiments, wherein the cationic polymer has a molar mass of at least about 100,000 g/mol.
[37.] The composition of any one of the above embodiments, wherein the cationic polymer has a molar mass of up to about 1,000,000 g/mol.
[38.] The composition of any one of the above embodiments, wherein the cationic polymer has a solubility in water, at 25° C. and 100 kPa, of at least about 50 g/L.
[39.] The composition of any one of the above embodiments, wherein the cationic polymer has a solubility in water, at 25° C. and 100 kPa, of up to about 2,500 g/L.
[40.] The composition of any one of the above embodiments, wherein the cationic polymer comprises a compound of formula (I):

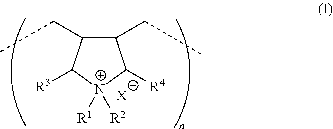

wherein,

each of R¹-R⁴ is independently —H, alkyl, or substituted alkyl;

X is a suitable atom or group of atoms, capable of forming the monovalent anion; and

n is 2 to about 250,000.

[41.] The composition of any one of the above embodiments, wherein the cationic polymer comprises at least one of:

polydiallyldimethylammonium chloride (polyDADMAC);

cationic acrylamide emulsion comprising a copolymer of acrylamide and dimethylaminoethylmethacrylate quaternary acid salt;

poly[(3-(methacryloylamino)-propyl]trimethylammonium chloride);

poly (acrylamido-N-propyltrimethylammonium chloride); and

chitosan-graft-poly (acrylamide-methacrylatoethyl trimethyl ammonium chloride) (PCAD).

[42.] The composition of any one of the above embodiments, wherein the cationic polymer comprises polydiallyldimethylammonium chloride (polyDADMAC), CAS No. 26062-79-3.
[43.] The composition of any one of the above embodiments, wherein the composition comprising the cationic polymer and water has a pH of about 6 to about 8.
[44.] The composition of any one of the above embodiments, wherein the composition comprising the cationic polymer and the water comprises the cationic polymer in up to about 20 wt. % of the composition.
[45.] The composition of any one of the above embodiments, wherein the composition comprising the cationic polymer and the water comprises the cationic polymer in at least about 0.001 wt. % of the composition.
[46.] The composition of any one of the above embodiments, wherein the composition comprising the cationic polymer and the water comprises the cationic polymer in about 0.01 wt. % to about 1.0 wt. % of the composition.

### EXAMPLES

### Example 1

Core flow tests were carried out on sandpacks to evaluate the effectiveness of DADMAC treatment. Incremental differential pressure was applied to evaluate particle mobilization with and without DADMAC treatment (control test). Turbidity analysis was carried out on the collected fluid. Regained permeability was also determined after DADMAC treatment. This study helped understand whether the particles are dislodging after the treatment and agglomeration has occurred or not. Sieve analysis and microscopic analysis were performed to evaluate particle agglomeration.

Sand Pack composition: Silica flour and 20/40 Ottawa sand (50:50)

Treatment fluid: 0.1% hydrated solution of DADMAC

### Test Procedure:

Sandpack was prepared using silica flour and 20/40 sand (50:50), with additional layers of 20/40 sand (˜1 cm) at both ends. Two ends of pack were closed using 300 meshes. The pack was saturated with 3% KCI and initial permeability was determined

Through this pack 0.1% hydrated solution of DADMAC was pumped and pack was shut in for 24 hrs at 150° F.

After 24 hrs, final permeability was determined by changing the mesh size to 40 mesh. The fluid was also collected for turbidity analysis under different pressures.

Results of initial/final permeability and turbidity analysis are tabulated in Table 1.

TABLE 1

| | | | Sandpack-2 Control | |
|---|---|---|---|---|
| | Sandpack-1 with | | Sample without | |
| Permeability | DADMAC treatment | | treatment | |
| Initial Brine Permeability | 450 | mD | ~400 | mD |
| Final Permeability | 3100 | mD | ~400 | mD |
| Turbidity analysis | | | | |
| At 25 psi | 14 | NTU | 450 | NTU |
| At 50 psi | 8 | NTU | 505 | NTU |

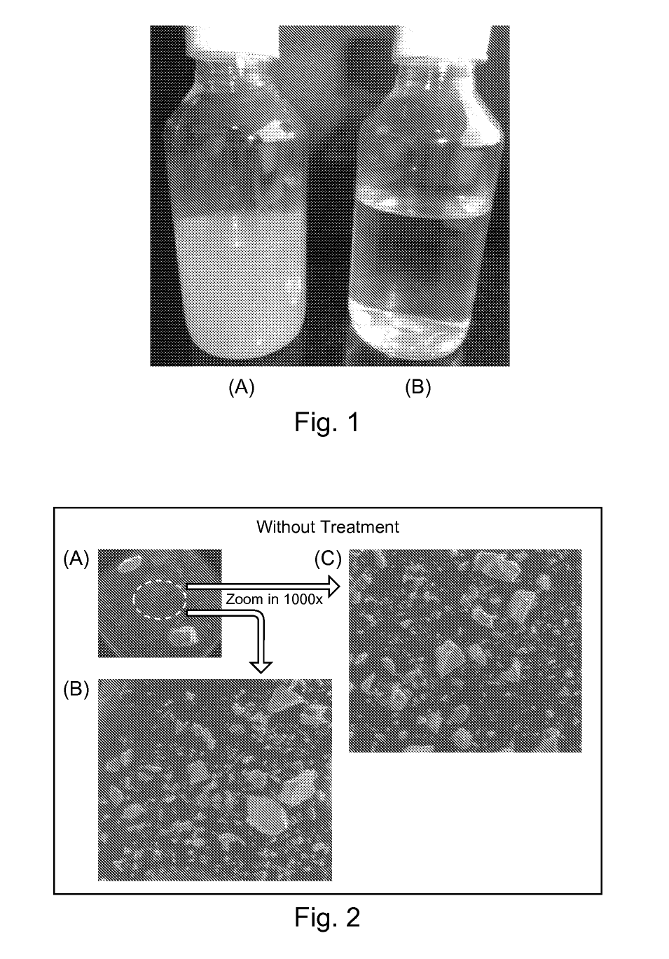

Observations from Table 1 and FIG. 1:

Regained perm

A good regained permeability observed during the tests definitely ensures that the fluid did not damage the formation.

Turbidity analysis

Clear solution collected under pressure (FIG. 1 B) after DADMAC treatment confirms that the newly identified treatment was able to hold the fines particles upto 200 psi. Whereas in control sample (FIG. 1A) high turbidity value (400 NTU) reveals the continuous flow of fines under pressure due to absence of fines agglomeration.

In order to see agglomeration of particles, scanning electron micrographs (SEM) were taken after polymer treatment and compared against control run (without any treatment).

In FIG. 2, SEM micrograph (A) is for mixture of Silica flour+20/40 sand (50:50) without any chemical treatment. The morphology of loose sand grains (20/40 sand) marked as sand along with fines (Silica flour) is depicted in dotted circle.

Micrographs (B) and (C) are zoom in images at 1OOOx, for dotted area of Silica flour. At higher resolution, we can easily see loosely dispersed fines particles with varied size range. Fines are randomly distributed and no agglomeration is observed.

In FIG. 2A: WD=10.0 mm, HV=20.00 kV, mag=50×, det=LFD, pressure=65 Pa, and HFW=597 μm. In FIG. 2B: WD=9.8 mm, HV=20.00 kV, mag=1,000×, det=LFD, pressure=65 Pa, and HFW=298 μm. In FIG. 2C: WD=9.8 mm, HV=20.00 kV, mag=1,000×, det=LFD, pressure=65 Pa, and HFW=298 μm.

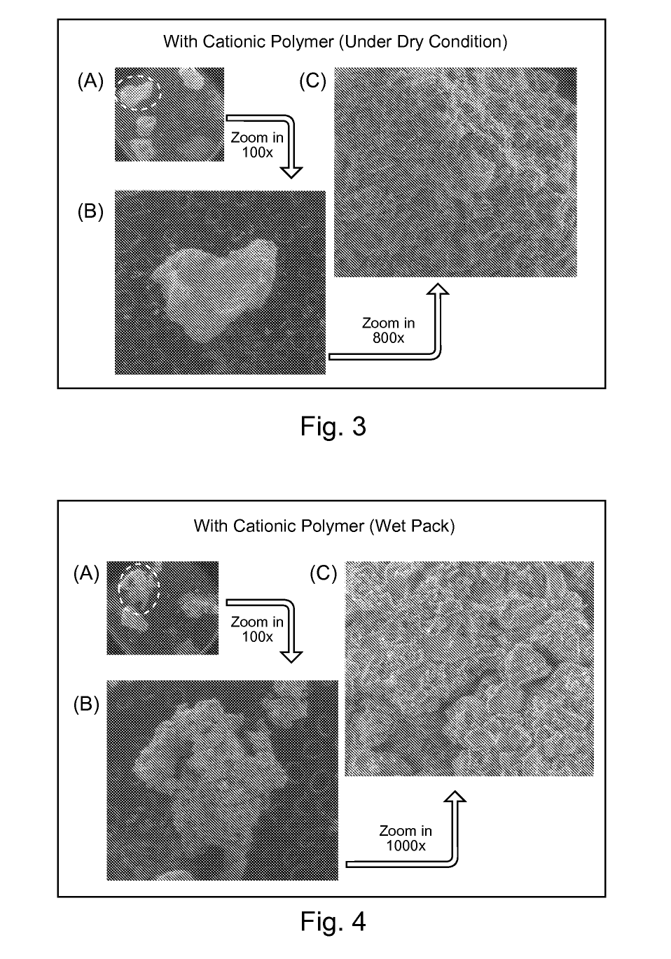

In FIG. 3, SEM micrograph (A) is taken after treating mixture of Silica flour+20/40 sand (50:50) using cationic polymer. After chemical treatment, the treated pack was dried and then SEM was carried out.

Few agglomerates are observed in image (A). One of the agglomerates shown in dotted line is zoom in at 100× in image (B) and this was further analyzed at higher resolution of 800× (image C). One can clearly see agglomeration of loosely dispersed Silica flour (as observed in FIG. 2) converted into a small chunk of particles, in presence of DADMAC. These micrographs clearly confirm particle agglomeration does exist.

In FIG. 3A: WD=10.0 mm, HV=20.00 kV, mag=50×, det=LFD, pressure=65 Pa, and HFW=597 μm. In FIG. 3B: WD=9.6 mm, HV=20.00 kV, mag=100×, det=LFD, pressure=65 Pa, and HFW=298 μm. In FIG. 3C: WD=9.6 mm, HV=20.00 kV, mag=800×, det=LFD, pressure=65 Pa, and HFW=373 μm.

In FIG. 4, SEM micrograph (A) is taken after treating mixture of Silica flour+20/40 sand (50:50) using DADMAC. After chemical treatment, the treated pack was removed under wet condition and then SEM was carried out.

In FIG. 4A: WD=8.4 mm, HV=20.00 kV, mag=50×, det=LFD, pressure=65 Pa, and HFW=597 μm. In FIG. 4B: WD=10.1 mm, HV=20.00 kV, mag=100×, det=LFD, pressure=65 Pa, and HFW=298 μm. In FIG. 4C: WD=9.9 mm, HV=20.00 kV, mag=1,000×, det=LFD, pressure=65 Pa, and HFW=298 μm.

One can clearly see agglomeration of particles under wet condition as well.

1. A method of treating a subterranean formation, the method comprising:
placing in the subterranean formation a composition comprising a cationic polymer and water.

2. The method of claim 1, wherein the subterranean formation comprises a sandstone formation, comprising at least about 50 wt. % quartz.

3. The method of claim 1, wherein the treating the subterranean formation comprises at least one of: (1) agglomerating subterranean formation particles, (2) decreasing the amount of small-sized particles in a subterranean formation, (3) reducing particle migration located downhole, (4) decreasing the amount of subterranean particles that enter into a downhole well, and (5) forming agglomerated particles in a subterranean formation.

4. The method of claim 3, wherein subterranean formation permeability is substantially maintained.

5. The method of claim 1, wherein the treating the subterranean formation comprises at least one of: (1) agglomerating subterranean formation particles, (2) decreasing the amount of particles in a subterranean formation, (3) reducing particle migration located downhole, and (4) decreasing the amount of subterranean particles from entering into a downhole well;
wherein the particles comprise at least one of sand and clay, having a diameter size of about 50 microns, or less.

6. The method of claim 1, wherein any resin present in the composition comprising the cationic polymer and the water is present in less than about 0.1 wt. % of the composition.

7. The method of claim 1, wherein the cationic polymer has a molar mass of about 100,000 g/mol to about 1,000,000 g/mol.

8. The method of claim 1, wherein the cationic polymer has a solubility in water, at 25° C. and 100 kPa, of about 50 g/L to about 2,500 g/L.

9. The method of claim 1, wherein the cationic polymer includes a compound of formula (I): 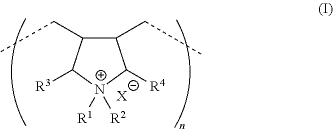
wherein,
each of R¹-R⁴ is independently —H, alkyl, or substituted alkyl;
X is a suitable atom or group of atoms, capable of forming the monovalent anion; and
n is 2 to about 250,000.

10. The method of claim 1, wherein the cationic polymer comprises at least one of:
polydiallyldimethylammonium chloride (polyDADMAC),
cationic acrylamide emulsion comprising a copolymer of acrylamide and dimethylaminoethylmethacrylate quaternary acid salt;
poly[(3-(methacryloylamino)-propyl]trimethylammonium chloride;
poly (acrylamido-N-propyltrimethylammonium chloride); and
chitosan-graft-poly (acryl amide-methacrylatoethyl trimethyl ammonium chloride) (PCAD).

11. The method of claim 1, wherein the cationic polymer comprises polydiallyldimethylammonium chloride (polyDADMAC).

12. The method of claim 1, wherein the composition comprising the cationic polymer and water has a pH of about 6 to about 8.

13. The method of claim 1, wherein the composition comprising the cationic polymer and the water comprises the cationic polymer in about 0.001 wt. % to about 20 wt. % of the composition.

14. The method of claim 1, further comprising obtaining or providing the composition, wherein the obtaining or providing of the composition is performed downhole.

15. The method of claim 1, further comprising obtaining or providing the composition, wherein the obtaining or providing of the composition is performed above the surface.

16. The method of claim 1, wherein during the contacting of the composition with the subterranean material downhole, the conditions comprise a temperature of about 25° C. to about 150° C.

17. The method of claim 1, further comprising combining the composition with an aqueous or oil-based fluid.

18. The method of claim 1, wherein at least one of prior to, during, and after the contacting of the subterranean material and the composition, the composition is used downhole, at least one of alone and in combination with other materials, as a drilling fluid, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof.

19. The method of claim 1, wherein the composition further comprises at least one of water, saline, aqueous base, oil, organic solvent, synthetic fluid oil phase, aqueous solution, alcohol or polyol, cellulose, starch, alkalinity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, gas, weight reducing additive, heavy-weight additive, lost circulation material, filtration control additive, dispersant, salt, fiber, thixotropic additive, breaker, crosslinker, gas, rheology modifier, density control agent, curing accelerator, curing retarder, pH modifier, chelating agent, scale inhibitor, enzyme, resin, water control material, polymer, oxidizer, and a marker.

20. A method for agglomerating subterranean formation particles, the method comprising:
placing in the subterranean formation a composition comprising a cationic polymer and water.
